(19) United States
(12) Patent Application Publication
(10) Pub. No.: US 2023/0288615 A1
(43) Pub. Date: Sep. 14, 2023

(54) GRADIENT-INDEX FREEFORM HEAD MOUNTED DISPLAY AND HEAD-UP DISPLAY

(71) Applicant: Qioptiq Limited, St. Asaph (GB)

(72) Inventor: Andrew Boyd, St. Asaph (GB)

(21) Appl. No.: 18/319,637

(22) Filed: May 18, 2023

Related U.S. Application Data
(63) Continuation of application No. PCT/US2021/057098, filed on Oct. 28, 2021.
(60) Provisional application No. 63/116,264, filed on Nov. 20, 2020.

(51) Int. Cl. G02B 3/00; G02B 27/01; G02B 13/00; G02B 17/08

(52) U.S. Cl. CPC G02B 3/0087; G02B 27/0172; G02B 27/0101; G02B 13/0095; G02B 17/0816; G02B 2027/011; G02B 2027/0116

(57) ABSTRACT

An optical projection assembly directs a first image to an eyebox of a user combined with light from a second source. A relay optic has a non-rotationally symmetric refractive gradient-index (GRIN) component arranged to receive the first image. A tilted, partially reflective combiner has a tilted first surface to receive and transmit the light from the second source, and an opposite second surface to receive and project the first image from the relay optic and transmit the light received from the second source to the eyebox. The GRIN component is configured to reduce a perceivable aberration of the first image introduced by the combiner.

### CROSS-REFERENCE TO RELATED APPLICATIONS

This application claims the benefit of U.S. Provisional Patent Application Ser. No. 63/116,264, filed Nov. 20, 2020, entitled “Gradient-Index Freeform Head Mounted Display and Head-Up Display,” which is incorporated by reference herein in its entirety.

### FIELD OF THE INVENTION

The present invention relates to optical device, and more particularly, is related to a head mounted display (HMD) or head-up display (HUD).

### BACKGROUND

As shown by FIG. 1, a head mounted display (HMD) 100 projects an image of symbology from a relay optic 120 to a brow mirror 130. The brow mirror reflects the projected symbology image upon a combiner 140. The combiner 140 merges imagery from the outside world 170 with the symbology image, so the combined image may be viewed from within a volume known as an eyebox 150, with either one or two eyes dependent on position, or design application. A head-up display (HUD, not shown) makes use of similar optical design principles, but uses a different configuration from the HMD 100.

In general, space envelope constraints mean that the combiner 140 generally takes the form of a tilted piece of optical material, with negligible optical power in transmission, but positive optical focusing power in reflection. The application of optical power on the tilted surface of a combiner 140 inherently creates aberrations that must be corrected by the HUD/HMD relay optics 120. In particular, tilted spherical surfaces of the combiner 140 generate a significant amount of aberration, yet see widespread use as they are economical to manufacture.

FIG. 2 shows an off-axis HMD/HUD device 200. Removal of the aberrations generated by the surface of the combiner 240 often requires a complex arrangement of tilted and decentred lens components, and making use of complex optical surfaces such as aspheres, cylinders, toroids or freeforms. These optical surfaces are notoriously difficult to manufacture, particularly when large departure from a sphere is required. FIG. 2 shows a conventional HMD optic 220 with six tilted and decentred lens elements including two aspheric surfaces and one toric surface. This approach adds mass and complexity to the optical fabrication and assembly of the product. Further, the lenses of the optical assembly in the relay optics 220 must also correct chromatic aberrations, which is achieved by the introduction of one or more cemented doublet components or diffractive-refractive hybrid surfaces. The requirement to correct chromatic aberrations may be further compounded when the system has a full-colour RGB display rather than monochrome green. Therefore, there is a need in the industry to address one or more of the above-mentioned shortcomings.

### SUMMARY

Embodiments of the present invention provide a gradient-index freeform head mounted display and head-up display. Briefly described, the present invention is directed to an optical projection assembly that directs a first image to an eyebox of a user combined with light from a second source. A relay optic has a refractive gradient-index (GRIN) component arranged to receive the first image. A tilted, partially reflective combiner has a tilted first surface to receive and transmit the light from the second source, and an opposite second surface to receive and project the first image from the relay optic and transmit the light received from the second source to the eyebox. The GRIN component is configured to reduce a perceivable aberration of the first image introduced by the combiner.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram showing a basic head mounted display (HMD) system.

FIG. 2 is a schematic diagram of an implementation of the head mounted display system of FIG. 1, using aspheric, toric, tilted and decentred lens components.

FIG. 3A is a schematic diagram of a first exemplary embodiment of a GRIN HMD system.

FIG. 3B is a schematic diagram of the first exemplary embodiment of a GRIN HMD system of FIG. 3A indicating the optical axis.

FIG. 4 is a schematic diagram of a second exemplary embodiment of a GRIN HMD system with freeform GRIN plates cemented to conventional aspheric lenses.

FIG. 5 is a flowchart of an exemplary embodiment of a method for manufacturing an optical projection assembly configured to combine received external light with a projected image from an electronic display at an eyebox of a user.

FIG. 6 is a listing of material properties for a first GRIN lens under the second embodiment of FIG. 4.

FIG. 7 is a listing of material properties for a second GRIN lens under the second embodiment of FIG. 4.

FIG. 8 is a schematic diagram of a third exemplary embodiment of a GRIN HMD system single element freeform GRIN optics.

FIG. 9 is a schematic diagram of a fourth exemplary embodiment of a GRIN HUD system.

FIG. 10 is a schematic diagram of the fourth exemplary embodiment of the GRIN HUD system of FIG. 9 indicating arrangement of optical elements.

### DETAILED DESCRIPTION

The following definitions are useful for interpreting terms applied to features of the embodiments disclosed herein, and are meant only to define elements within the disclosure.

As used within this disclosure, “freeform GRIN” refers to a distribution of variable refractive index within an optical component that lacks an axis of rotational symmetry.

As used within this disclosure, “toric GRIN” refers to a distribution of variable refractive index within an optical component that varies independently in two perpendicular meridians, conforming to a GRIN distribution of form:

$$N = {\sum }_{i = 0}^{j} {N}_{{x}_{2 i}} {x}^{2 i} + {\sum }_{k = 0}^{l} {{N}_{{ρ}_{2 k}} ( {x}^{2} + {y}^{2} )}^{k} \qquad ( Eq . 1 )$$

About a defined axis through the lens that may be tilted, rotated or decentred with respect to the optical axis.

As used within this disclosure, “cylindrical GRIN” refers to a distribution of variable refractive index within an optical component that varies independently in one single meridian, conforming to a GRIN distribution of form:

$$N = {\sum }_{i = 0}^{j} {N}_{{x}_{2 i}} {x}^{2 i} \qquad ( Eq . 2 )$$

About a defined axis through the lens that may be tilted, rotated or decentred with respect to the optical axis.

As used within this disclosure, a “relay lens” refers to an optical device that generates a pair of real images, often used to project an intermediate image onto an image plane, or to invert said intermediate image.

As used within this disclosure, a “head-up display” (HUD) refers to a transparent display that presents data without requiring a user to look away from his usual viewpoint.

As used within this disclosure, a “head mounted display” refers to a display device worn on the head or as part of a helmet of a user that has a small display optic in front of one (monocular HMD) or each eye (binocular HMD).

As used within this disclosure gradient-index (GRIN) optics refers to a branch of optics covering optical effects produced by a gradient of the refractive index of a material. Such gradual variation may be used to produce lenses with flat surfaces, or lenses that do not have the aberrations typical of traditional spherical lenses. There are several fabrication methods for GRIN systems, including a Volumetric Index of Refraction Gradient Optics (VIRGO) printing technique developed by Vadient Optics (Portland, Oreg.), where inkjet printing of nanoparticle doped inks is used to deposit gradient-index media. This process theoretically allows any distribution of index within boundaries imposed by the printer resolution and base material refractive indices, and a large number of materials to be deposited in a highly scalable process. Another reference to additive manufacture GRIN, referred to as “the sol-gel based direct ink writing (DIW) approach” developed by Lawrence Livermore National Labs may be found at www.science.org/doi/10.1126/sciadv.abc7429. The manufacture of such GRIN optics is described in several patents, for example, U.S. Pat. No. 9,903,984 B1 (“Achromatic Optical-Dispersion Corrected Refractive-Gradient Index Optical-Element for Imaging Applications”), U.S. Pat. No. 9,555,623 B1 (“Refractive Gradient Inkjet Printing”), U.S. Pat. No. 9,447,299 B2 (“Inks for 3D Printing Gradient Refractive Index (GRIN) Optical Components”), and 3.4 U.S. Pat. No. 9,623,609 B2 (“Method of manufacturing multi-component functional article”), each of which is incorporated herein by reference in its entirety.

As used within this disclosure, a “coordinate break” refers to a defined point in a lens system where one coordinate system is transformed to another.

As used within this disclosure, “decentre” refers to a lateral shift of one coordinate system with respect to another.

As used within this disclosure, “tilt” refers to an angular shift of one coordinate system with respect to another.

As used within this disclosure, “Tilt/Decentre and bend” refers to a surface that is tilted/decentred following a coordinate break, with a second coordinate break thereafter which bends the optical axis to match a reflected ray of light from mirror located at the surface pole.

As used within this disclosure, “Tilt/Decentre and return” refers to a surface that is tilted or decentred with respect to a coordinate system, whereafter a second coordinate break returns the optical axis to that prior to the surface.

Reference will now be made in detail to embodiments of the present invention, examples of which are illustrated in the accompanying drawings. Wherever possible, the same reference numbers are used in the drawings and the description to refer to the same or like parts.

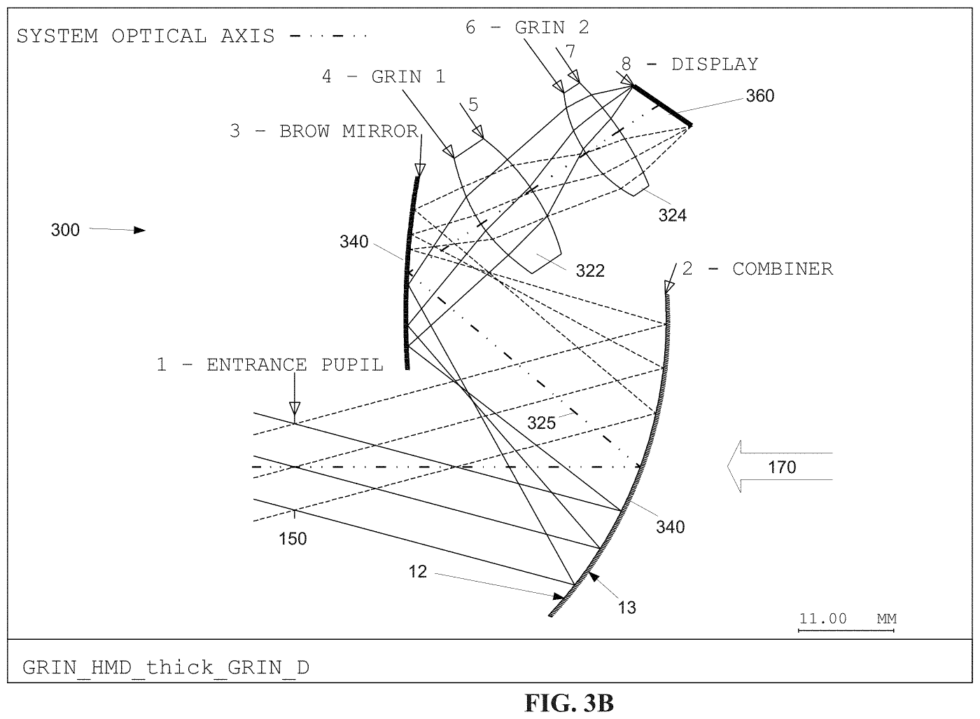

Embodiments of the present invention include a display projection system, for example, a head mounted display or head-up display that does not obscure the outside world from the operator. A first embodiment of a GRIN HUD shown by FIG. 3A, includes a curved plate known as a combiner 340, contains a partially reflective coating that reflects light from a brow mirror 330, refractive relay optic 320 and a display 360, whilst transmitting light from the outside world 170 to a focal volume 150, here an eyebox 150 of a user and introducing minimal optical aberration, much like the visor of a helmet.

Light that is reflected from the combiner 340 becomes substantially aberrated with coma and astigmatism. The light from the display 360 that strikes the combiner 340 is therefore “pre-aberrated” by the refractive relay optic 320 with aberrations of the opposite sign and equal magnitude. The result of that is near net-zero aberration when the light reaches the eyebox 150.

The combiner 340 applies optical focusing power, without which the bundles of rays that converge to the eyebox 150 would become unfeasibly far separated. Instead, the combiner 340 collimates these ray bundles from an intermediate image 380 (indicated by the dash-dot box) that forms between the combiner 340 and the brow mirror 330.

The purpose of the refractive relay optic 320 therefore, is to focus light to the intermediate image 380 between the combiner 340 and the brow mirror 330 that creates an inverse level of aberration required to counteract the aberration of the combiner 340. This is achieved by introducing asymmetric terms to the index distribution of GRIN lenses of 322, 324 of the refractive relay optic 320.

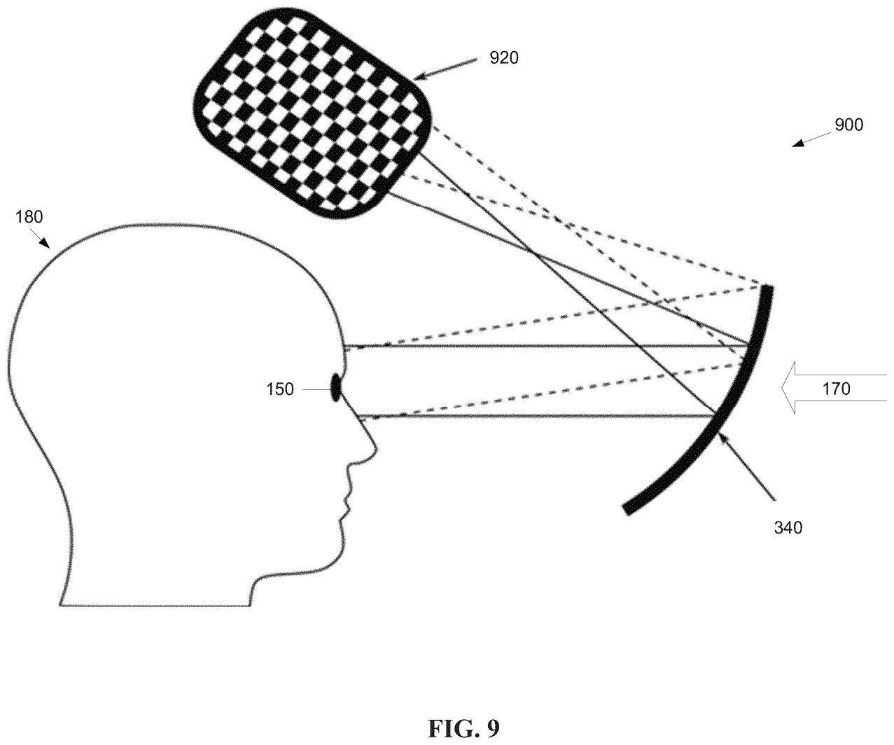

Under the present embodiments, the GRIN head-up display (HUD) 300 or head mounted display (HMD) 900 (FIG. 9) projects an image to a user via the combiner 340 that merges imagery from the outside world 170 and symbology generated on the display 360. The embodiments use a number of GRIN components 322, 324 of arbitrary distribution to eliminate the aberrations induced by a tilted surface of the combiner 340. In particular, the GRIN components 322, 324 contains an index distribution that is non-rotationally symmetric about an optical axis 325 (FIG. 3B) of the refractive relay optic 320. This freeform GRIN removes optical aberrations induced by the combiner 340.

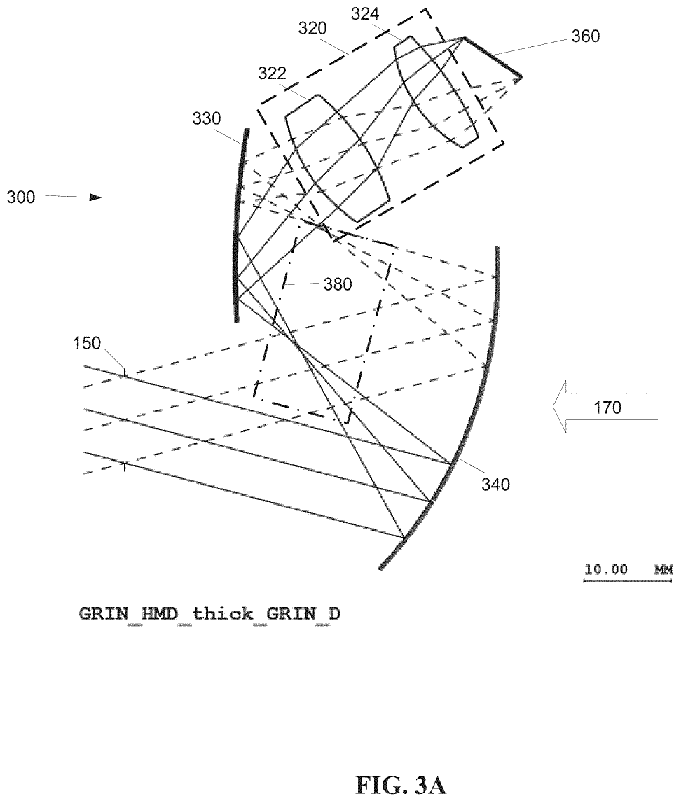

As compared with the existing off-axis HMD/HUD device 200 (FIG. 2) described in the background section, under the embodiments freeform, toric, and cylindrical surfaces are replaced and superseded. The GRIN lenses 322, 324 of the embodiments reduce the number of lenses in the refractive relay optic 320 compared to the relay optic 220 (FIG. 2) head mounted display by generating asymmetric degrees of freedom for the correction of asymmetric aberrations.

The embodiments employ freeform GRIN to replace the cemented doublet and diffractive components used by existing off-axis HMD/HUD device 200 (FIG. 2), and likewise to replace the tilted and decentred lens components. The embodiments apply freeform GRIN media to the problem of aberration correction in off-axis HUDs and HMDs, with the advantage of reduced mass and complexity. For example, under the first embodiment 300 the number of components in the refractive relay optic 320 is reduced from six (see FIG. 2) to two 322,324. The need for tilted and decentred components is eliminated, which greatly simplifies the manufacture of a mechanical housing (not shown). The first embodiment uses a common mechanical axis for the lens housing which is more easily machined. In some embodiments, the optical surfaces of the lenses may also sit about a common axis. The embodiments negate the need for cylindrical, toric, or freeform surfaces used by existing off-axis HMD/HUD device 200 (FIG. 2).

The first exemplary embodiment 300 of an HMD device uses GRIN optics to correct chromatic aberrations in addition to the correction of monochromatic aberrations induced by the tilted combiner 340. For purposes of example only, first embodiment 300 is a fixed-visor head mounted display: alternative embodiments may be directed to different applications with a wide range of constructions and space envelopes that may apply to, for example avionic optical design problems. The first embodiment is, however, directed to addressing a problem common to a large number of avionic systems, namely, the removal of aberrations induced by a tilted, powered combiner.

As shown by FIG. 3A ray bundles (indicated by solid and dashed lines) reach an approximate focus (whilst being highly aberrated), and also no components foul any adjacent ray bundles. For simplicity, the first embodiment is kept in planar symmetry. In alternative embodiments a space envelope more conformal to the human head could be obtained with the use of compound angles in the combiner 340 and brow mirror 330.

For the GRIN components under the first embodiment, a common optical axis is retained through the refractive relay optic 320. Retaining a common axis significantly simplifies mechanical design, machining, and inspection of the lens housing. The GRIN freeform degrees of freedom compensate for the aberrations generated by lens tilt and decentre.

Under the first embodiment the curvature of the combiner 340 is fixed at 50 mm radius of curvature. The geometry of the brow mirror 330 was considered to be a useful degree of freedom in design. For example, the brow mirror 330 may be a diamond turned reflective surface; aspheric terms and radius of curvature were used to enhance aberration correction.

The GRIN lenses are composed of blends of up to three homogeneous base materials (see below). These homogeneous base materials form a heterogeneous GRIN lens when combined in a spatially varying alloy. The refractive index may be computed from the material space equation for linear index blending:

$$N = \frac{{N}_{A} {m}_{A} + {N}_{B} {m}_{B} + {N}_{C} {m}_{C}}{{m}_{A} + {m}_{B} + {m}_{C}} \qquad ( Eq . 3 )$$

Where N_{A}, N_{B}, N_{C} are the refractive indices of the base materials A, B, and C respectively, and m_{A}, m_{B} and mc represent the volumetric relative composition of materials A, B, and C when normalised. The relative composition coefficients were a function of X and Y coordinates perpendicular to the optical axis (see Eq. 6, below).

Selection of GRIN materials for a specific application may be aided using optical modeling software, for example, in this case, CodeV, among other possibilities, which enables optimisation of GRIN designs using native CodeV GRIN coefficients. Modelling of the asymmetric GRIN distribution requires a user-modified routine, implemented as either “macro” code within the optical design software or as an external raytracing .dll that returns the GRIN refractive index and its derivatives. Use of a .dll file provides additional computation speed to enable efficient design of HUDs/HMDs, which are larger computational problems than rotationally symmetric lens designs. A non-rotationally symmetric design should involve field sampling over positive and negative field angles in both X and Y fields to account for asymmetry in the aberrations of the image, as well as a plurality of rays over each individual field, due to the potentially rapid variation of aberrations over the lens pupil. Furthermore, to correct the aberrations of a non-rotationally symmetric design involves more optimisation degrees of freedom than a rotationally symmetric solution. Expansion of the number of degrees of freedom means that more derivatives must be computed during lens optimisation which again increases the computational load.

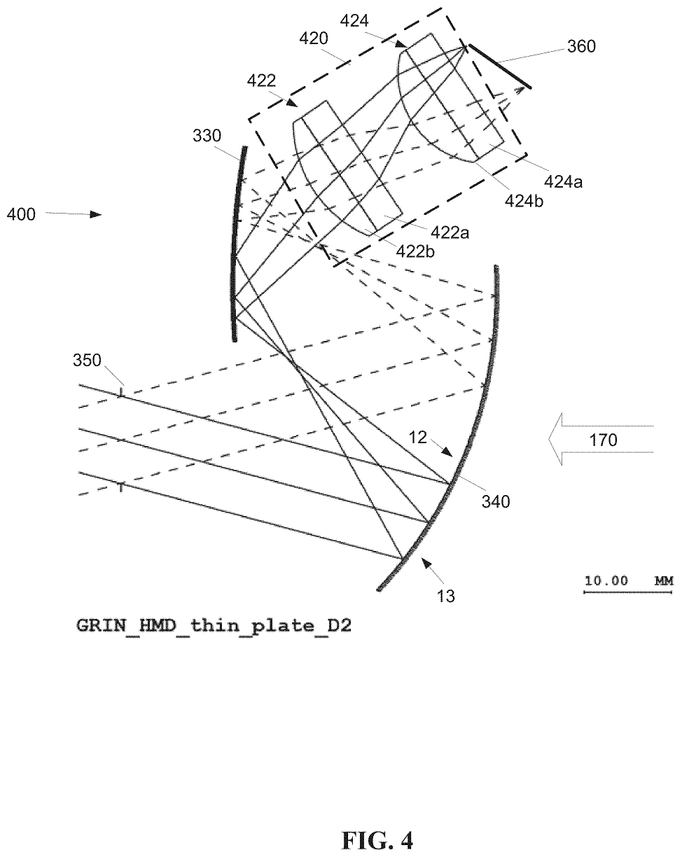

Printing parts with significant thickness may be difficult and costly to fabricate. Therefore, as shown by FIG. 4, a second embodiment 400 employs a refractive relay optic 420 a hybrid GRIN/surface driven design variant that makes use of GRIN to provide mostly non-rotationally symmetric “freeform” degrees of freedom, whilst leaving generation of focusing power to conventional glass lens elements. Here, GRIN components are leveraged for the more challenging freeform contribution requirement (which the GRIN may potentially achieve at significantly lower cost than a freeform surface). The optical construction of the refractive relay optic 420 includes of two cemented doublets 422, 424, where each doublet includes a glass lens 422b, 424b backed by a GRIN plate 422a, 424a.

As shown in FIG. 4, under the second embodiment the system 400 consists of three optical assemblies 420, 330, 340 and one opto-electronic component 360. The optical components include a partially reflective combiner 340, a brow mirror 330 and a refractive relay optic 420 having two hybrid GRIN lenses 422, 424. The opto-electronic component is a luminous display panel 360, for example, a commercially available luminous display panel. While the second embodiment was designed for an 800×600 resolution 15 μm pixel pitch display, a range of display types may be used provided they occupy the useful field of view of the system 400.

The distributed dispersion of the hybrid GRIN lenses 422, 424 is determined by the ΔN at three sequential wavelengths: short, mid, and long that cover the optical waveband of the HMD. Distributed dispersion is given by:

$${V}_{10} = \frac{Δ {N}_{λ mid}}{Δ {N}_{λ short} - Δ {N}_{λ long}} \qquad ( Eq . 4 )$$

where ΔN indicates a change in refractive index at the referenced wavelength dependent index reference point, and the wavelengths λ_{long}>λ_{mid}>λₛₕₒᵣₜ.

The hybrid GRIN lenses 422, 424 of the refractive relay optic 420 may be described via a model of relative composition, see Boyd [Proc SPIE Vol 10998, 2019]. It should be noted that the refractive relay optic 420 is different from, for example, a corrector plate that operates in collimated light and has negligible focusing power. The refractive index of each GRIN lens 422a, 424a is determined by the relative amounts of three base materials, A, B and C as described by the equation:

$$N ( x , y ) = \frac{{N}_{A} {m}_{A} ( x , y ) + {N}_{B} {m}_{B} ( x , y ) + {N}_{C} {m}_{C} ( x , y )}{{m}_{A} ( x , y ) + {m}_{B} ( x , y ) + {m}_{C} ( x , y )} \qquad ( Eq . 5 )$$

where x and y are Cartesian coordinates normal to the local optical axis of the GRIN component 422a, 424a and the relative composition factors mₙ are greater than zero at all points within the lens clear aperture. The relative composition factors of the nth material are functions of x and y and are defined by the equation:

mₙ=mₙ₀+mₙ₂ρ²+mₙ₄ρ⁴+mₙ₆ρ⁶+mₙₓx+m_{ny}y+mₙₓ₂x²+m_{ny2}y²+m_{ny3}y³+m_{nx2y}x²y (Eq. 6)

where ρ2=x²+y² and represents the square of the perpendicular distance from the optical axis.

The volumetric relative composition at any point within the material is described for material A, B and C as follows:

$$\begin{matrix}{M}_{A} = \frac{{m}_{A}}{{m}_{A} + {m}_{B} + {m}_{C}} & {M}_{B} = \frac{{m}_{B}}{{m}_{A} + {m}_{B} + {m}_{C}} & {M}_{C} = \frac{{m}_{C}}{{m}_{A} + {m}_{B} + {m}_{C}}\end{matrix} \qquad ( Eq . 7 )$$

The system field of view in the entrance pupil is defined by a circular field of semi-angle 20°, truncated by a y-plane absolute field of view of 15°. The system waveband covers the visible spectrum. In this embodiment, the system is defined for three wavelengths in the red, yellow, and blue regions of the spectrum as defined by the Fraunhofer C, D3 and F lines.

The system is illuminated by the display 360 placed at the focal plane of the system, emitting light that may sit within the aforementioned spectral waveband. The display 360 may be an emissive micro display based on OLED (organic light emitting diode) or similar technologies.

A number of surfaces are of aspheric form, whereby the surface sagitta is defined in the local optical axis by a conical cap of radius of curvature R added to even polynomial terms as follows:

$${Z}_{asph} = \frac{c {ρ}^{2}}{1 + \sqrt{1 - ( 1 + k ) {c}^{2} {ρ}^{2}}} + {A}_{4} {ρ}^{4} + {A}_{6} {ρ}^{6} + {A}_{8} {ρ}^{8} + … \qquad ( Eq . 8 )$$

Where c is the surface curvature defined as

$$c = \frac{1}{R} ,$$

k is the conic constant and Aₙ is the nth aspheric coefficient.

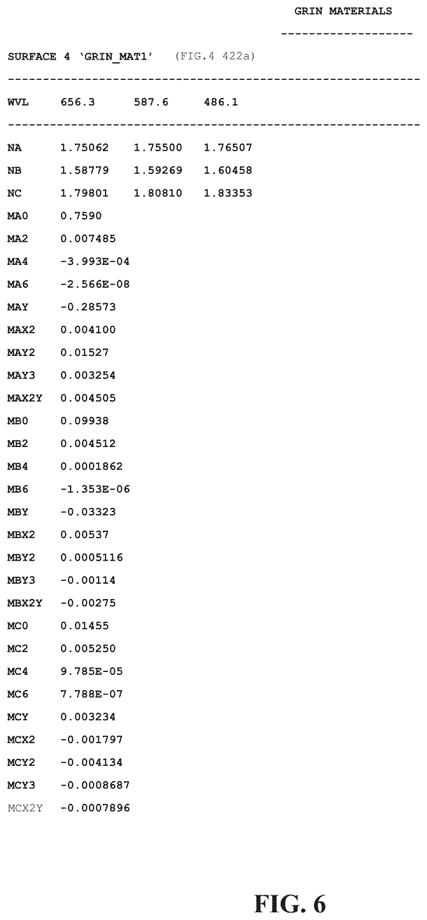

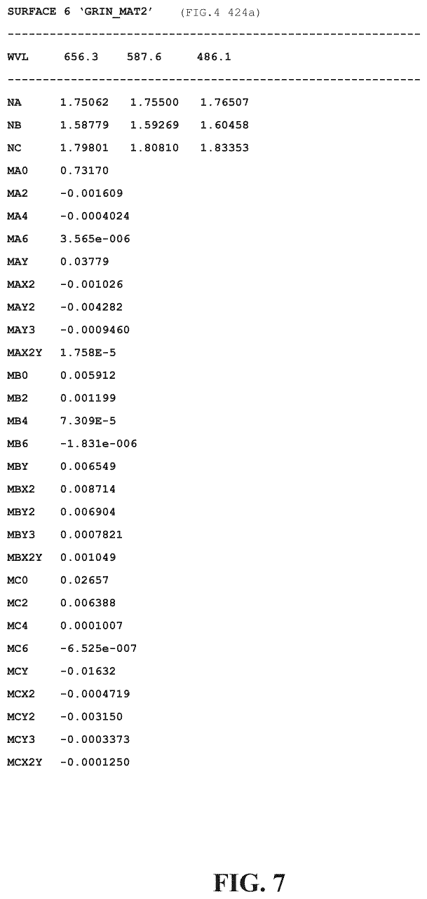

For purposes of providing a non-limiting example only, an exemplary construction of the second embodiment 400 (FIG. 4) is defined by a sequence of optical materials bounded by surfaces listed in tables 1-4 and FIGS. 6-7.

TABLE 1
GRIN HMD/HUD spectral waveband.

| | | | |
|---|---|---|---|
| Wavelengths | 0.5876 | 0.4861 | 0.6563 |
| Weights | 1.0000 | 1.0000 | 1.0000 |

TABLE 2
Surface Descriptions

| LABEL (FIG. 4 element) | SURFACE | RADIUS | THICKNESS | CLEAR APTRE | MATERIAL |
|---|---|---|---|---|---|
| OBJECT | 0 | INFINITY | INFINITY | INFINITY | AIR |
| ENTRANCE PUPIL (350) | 1 | INFINITY | 40.000000 | 10.0000 | AIR |
| COMBINER (340) | 2 | −50.000000 | −35.000000 | 70.5351 | REFLECT |
| BROW MIRROR (330) | 3 | 97.857188 | 10.109741 | 20.4440 | REFLECT |
| GRIN1 (422a) | 4 | 17.713851 | 7.106502 | 14.6757 | ‘GRIN_MAT1’ |
| | 5 | −25.327579 | 7.566754 | 12.0973 | AIR |
| GRIN2 (424a) | 6 | 15.791233 | 4.678940 | 13.0494 | ‘GRIN_MAT2’ |
| | 7 | −35.020876 | 5.666949 | 13.0792 | AIR |
| DISPLAY (360) | 8 | INFINITY | 0.000000 | 12.3804 | — |

TABLE 3
Aspheric Surfaces

| | | | | |
|---|---|---|---|---|
| SURFACE 3 | K: 0.00 | A4: 1.914933e−006 | A6: 0.000000e+000 | A8: 0.000000e+000 |
| SURFACE 4 | K: 0.00 | A4: −6.420656e−005 | A6: 0.000000e+000 | A8: 0.000000e+000 |
| SURFACE 6 | K: 0.00 | A4: 1.567224e−005 | A6: 0.000000e+000 | A8: 0.000000e+000 |

TABLE 4
DECENTRES AND TILTS

| Type | Y Decentre | X Decentre | Y Tilt | X Tilt |
|---|---|---|---|---|
| 2 Tilt/Decentre & | 0.000000 | 0.000000 | −20.000000 | 0.000000 |
| Bend | | | | |
| 3 Tilt/Decentre & | 0.000000 | 0.000000 | 37.000000 | 0.000000 |
| Bend | | | | |
| 8 Tilt/Decentre & | −0.069894 | 0.000000 | 21.292197 | 0.000000 |
| Return | | | | |

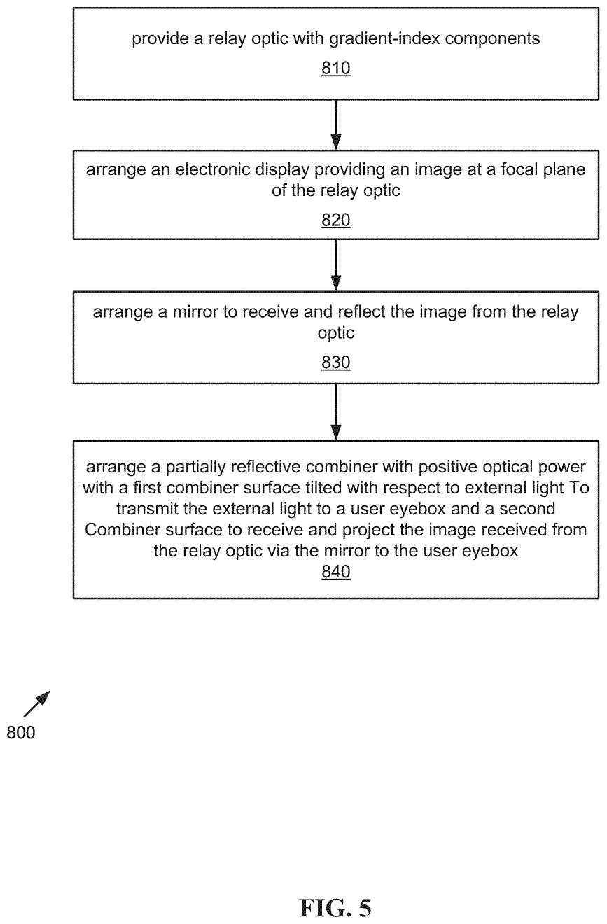

FIG. 5 is a flowchart of an exemplary embodiment of a method for manufacturing an optical projection assembly configured to combine received external light with a projected image from an electronic display at an eyebox of a user. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The method is described with reference to FIG. 4.

A refractive relay optic 420 with gradient-index (GRIN) components 422, 424 is provided, as shown by block 810. An electronic display 360 provides an image at a focal plane of the refractive relay optic 420, as shown by block 820. A mirror 330 is arranged to receive and reflect the image from the refractive relay optic 420, as shown by block 830. A partially reflective combiner 340 with positive optical power comprising a first surface 13 in a tilted fashion with respect to external light 170 to transmit the external light 170 to the eyebox 350 of a user, and a second surface 12 opposite the first surface arranged to receive and project the image received from the refractive relay optic 420 via the mirror 330 to the eyebox 350, as shown by block 840. The relay lens GRIN components 422, 424 are configured to address aberrations introduced by the combiner 340. It should be noted that in alternative embodiments the mirror of block 830 may be omitted, for example in a HUD embodiment.

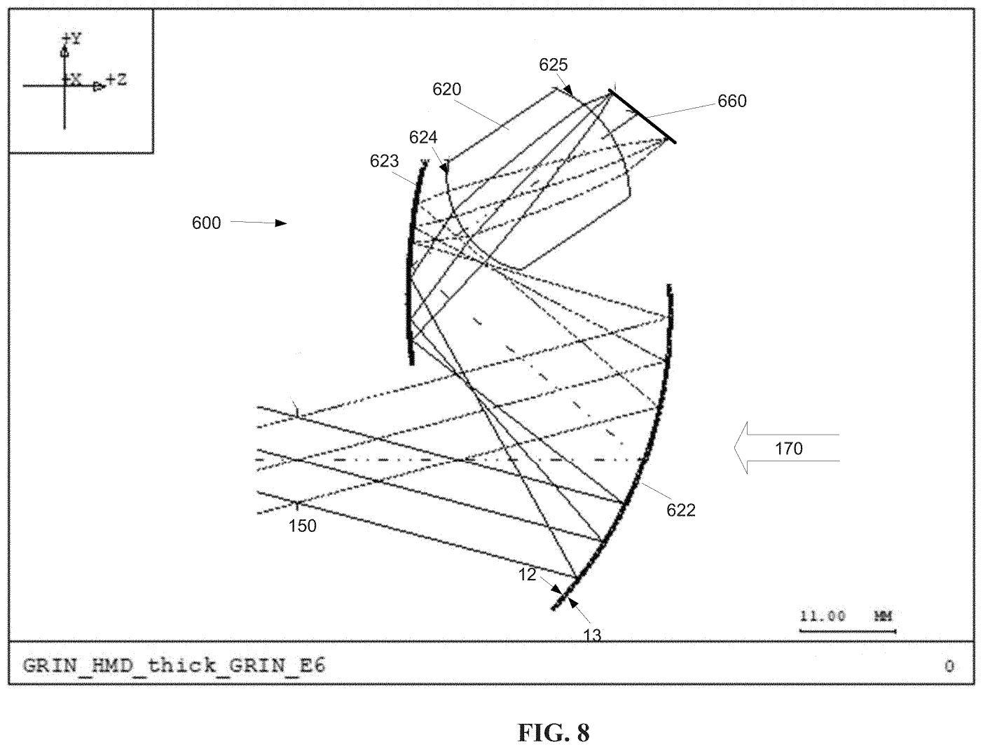

The embodiments presented above disclose a plurality of GRIN lenses. FIG. 8 shows an exemplary third embodiment 600 with a single GRIN element 620 and one opto-electronic component 660. The optical components include a partially reflective combiner 622, a brow mirror 623 and a refractive relay optic with the single GRIN element 620.

The third embodiment 600 includes a full freeform GRIN 620, both axially and radially, and involves a separate set of compositional materials from the first and second embodiments. The third embodiment is based on a printable ink, doped with nanoparticles, and uses available refractive index data. The third embodiment 600 is based on two ink “endpoints” with the GRIN acting as a relative composition between these two materials. The first material is an optical grade polyester, OKP4HT, that has been doped with hollow silica nanospheres to reduce the refractive index. The second material consists of OKP4 that has been doped with Zirconium oxide nanoparticles. All of these materials are commercially available. Polyester (or a similar material such as polystyrene) can be printed as monomers and UV cured.

Under the third embodiment, the clear aperture of the GRIN lens is defined as a surface that joins two end surfaces 624 and 625, being defined as the boundary surface of all rays to occupy a 40° circular field of view truncated to 30° vertical field of view in the eyebox. Outside the clear aperture boundary, the specified GRIN distribution does not apply, and the lens may consist of any material necessary for mechanical integration and reduction of stray light effects.

The GRIN of the third embodiment may described as a distribution of relative composition between two materials as determined by the equation:

$$N ( x , y ) = \frac{{N}_{A} {m}_{A} ( x , y , z ) + {N}_{B} {m}_{B} ( x , y , z )}{{m}_{A} ( x , y , z ) + {m}_{B} ( x , y , z )} \qquad ( Eq . 9 )$$

where x, y, and z are the three principal axes in the local coordinate system of the lens defined by the intersection of vertex of surface 4 with the optical axis. The optical axis is defined to be the z axis, with the x axis projecting out of the page. The relative composition of the nth material is defined by:

mₙ=(mₙ₀₀+mₙ₀₁z+mₙ₀₂z²)+(mₙ₂₀+mₙ₂₁z+mₙ₂₂z²)ρ²+(mₙ₄₀+mₙ₄₁z+mₙ₄₂z²)ρ⁴+(mₙ₆₀+mₙ₆₁z+mₙ₆₂z²)ρ⁶+(m_{ny10}+m_{ny11}z+m_{ny12}z²)y+(mₙₓ₂₀+mₙₓ₂₁z+mₙₓ₂₂z²)x²+(m_{ny20}+m_{ny21}z+m_{ny22}z²)y²+(m_{ny30}+m_{ny31}z+m_{ny32}z²)y³+(m_{nx2y10}+m_{nx2y11}z+m_{nx2y12}z²)x²y+(mₙₓ₄₀+mₙₓ₄₁z+mₙₓ₄₂z²)x⁴+(m_{ny40}+m_{ny41}z+m_{ny42}z²)y⁴+(m_{nx2y20}+m_{nx2y21}z+m_{nx2y22}z²)x²y² (Eq. 10)

The coefficients of each material in this GRIN design are listed in Table 5. The base index data for materials A and B are listed in Table 6. The volumetric relative composition at any point within the material is described for material A and B as follows:

$$\begin{matrix}{M}_{A} = \frac{{m}_{A}}{{m}_{A} + {m}_{B}} & {M}_{B} = \frac{{m}_{B}}{{m}_{A} + {m}_{B}}\end{matrix} \qquad ( Eq . 11 )$$

TABLE 5
Coefficients of thick GRIN E6 variant, (material ‘ZRO2GRIN’)

| | | | | | |
|---|---|---|---|---|---|
| mA00 | 3.84512 | mA01 | −0.09842 | mA02 | 0.00307 |
| mA20 | −0.01221 | mA21 | 0.00328 | mA22 | 3.47E−05 |
| mA40 | 6.005E−4 | mA41 | −5.049E−5 | mA42 | 1.60E−06 |
| mA60 | 1.40E−07 | mA61 | 3.60E−07 | mA62 | 5.28E−09 |
| mAy10 | −0.18028 | mAy11 | 0.03361 | mAy21 | −7.72E−04 |
| mAx20 | −0.07392 | mAx21 | −0.00284 | mAx22 | −1.19E−04 |
| mAy20 | −0.09091 | mAy21 | −0.00137 | mAy22 | −1.05E−04 |
| mAy30 | −0.00534 | mAy31 | 0.00168 | mAy32 | −8.93E−05 |
| mAx2y10 | −0.00362 | mAx2y11 | 0.00097 | mAx2y12 | −4.82E−05 |
| mAx40 | −3.966E−4 | mAx41 | 6.15E−05 | mAx42 | −2.32E−06 |
| mAy40 | 0.00092 | mAy41 | 8.42E−05 | mAy42 | −8.79E−06 |
| mAx2y20 | 0.00202 | mAx2y21 | −1.92E−04 | mAx2y22 | 5.20E−06 |
| mB00 | 0.92701 | mB01 | 0.23494 | mB02 | −0.01325 |
| mB20 | 0.01073 | mB21 | 0.01299 | mB22 | −7.13E−04 |
| mB40 | −0.00051 | mB41 | −4.16E−05 | mB42 | 9.55E−06 |
| mB60 | 5.840E−6 | mB61 | −4.30E−06 | mB62 | 1.63E−07 |
| mBy10 | 0.18547 | mBy11 | −0.00237 | mBy21 | −0.00093 |
| mBx20 | 0.03521 | mBx21 | 0.00675 | mBx22 | −2.74E−04 |
| mBy20 | −0.00603 | mBy21 | 0.00312 | mBy22 | 2.03E−05 |
| mBy30 | −0.00249 | mBy31 | −5.39E−04 | mBy32 | 5.42E−05 |
| mBx2y10 | 0.00118 | mBx2y11 | −4.04E−04 | mBx2y12 | 2.78E−05 |
| mBx40 | −0.00031 | mBx41 | 2.11E−04 | mBx42 | −1.79E−05 |
| mBy40 | −7.04E−04 | mBy41 | 5.17E−05 | mBy42 | −6.94E−06 |
| mBx2y20 | −0.00145 | mBx2y21 | 6.75E−04 | mBx2y22 | −4.80E−05 |

TABLE 6
Single element HMD E6 variant base materials indices

| | N(λ = | N(λ = | N(λ = |
|---|---|---|---|
| Refractive index | 656.3 nm) | 589.3 nm) | 486.1 nm) |
| Material A (ZrO2 | 1.703 | 1.711 | 1.725 |
| doped polyester) | | | |
| Material B (hollow | 1.577 | 1.584 | 1.602 |
| silica nanosphere | | | |
| doped polyester) | | | |

The overall optical construction of the system under the third embodiment is listed as follows:

TABLE 7
GRIN HMD/HUD spectral waveband

| | | | |
|---|---|---|---|
| Wavelengths | 0.5876 | 0.4861 | 0.6563 |
| Weights | 1.0000 | 1.0000 | 1.0000 |

TABLE 8
Elements

| LABEL | SURFACE | RADIUS | THICKNESS | DIAMETER | MATERIAL |
|---|---|---|---|---|---|
| EYEBOX | 601 | INFINITY | 40.000000 | 10.0000 | AIR |
| COMBINER | 622 | −50.000000 | −35.000000 | 70.5351 | REFLECT |
| BROW MIRROR | 623 | 73.650738 | 7.396742 | 20.7941 | REFLECT |
| GRIN | 624 | 12.372699 | 20.280000 | 13.7047 | ZRO2GRIN |
| | 625 | −13.645263 | 3.991656 | 11.2640 | AIR |
| DISPLAY | 660 | INFINITY | 0.000000 | 13.0264 | |

TABLE 9
SPECIAL SURFACES

| | | | | |
|---|---|---|---|---|
| 623 | Asphere K: 0.00 | A4: 2.061153e−006 | A6: 4.113439e−008 | A8: 0.000000e+000 |
| 624 | Asphere K: 0.00 | A4: 2.097612e−005 | A6: 1.666661e−006 | A8: 0.000000e+000 |
| 625 | Asphere K: 0.00 | A4: 8.096625e−005 | A6: −1.698017e−006 | A8: 0.000000e+000 |

TABLE 10
DECENTRES AND TILTS

| Element | Type | Y Decentre | X Decentre | Y Tilt | X Tilt |
|---|---|---|---|---|---|
| 622 | Tilt/Decentre | 0.000000 | 0.000000 | −20.000000 | 0.000000 |
| | & Bend | | | | |
| 623 | Tilt/Decentre | 0.000000 | 0.000000 | 37.000000 | 0.000000 |
| | & Bend | | | | |
| 660 | Tilt/Decentre | −0.082250 | 0.000000 | 16.800743 | 0.000000 |
| | & Return | | | | |

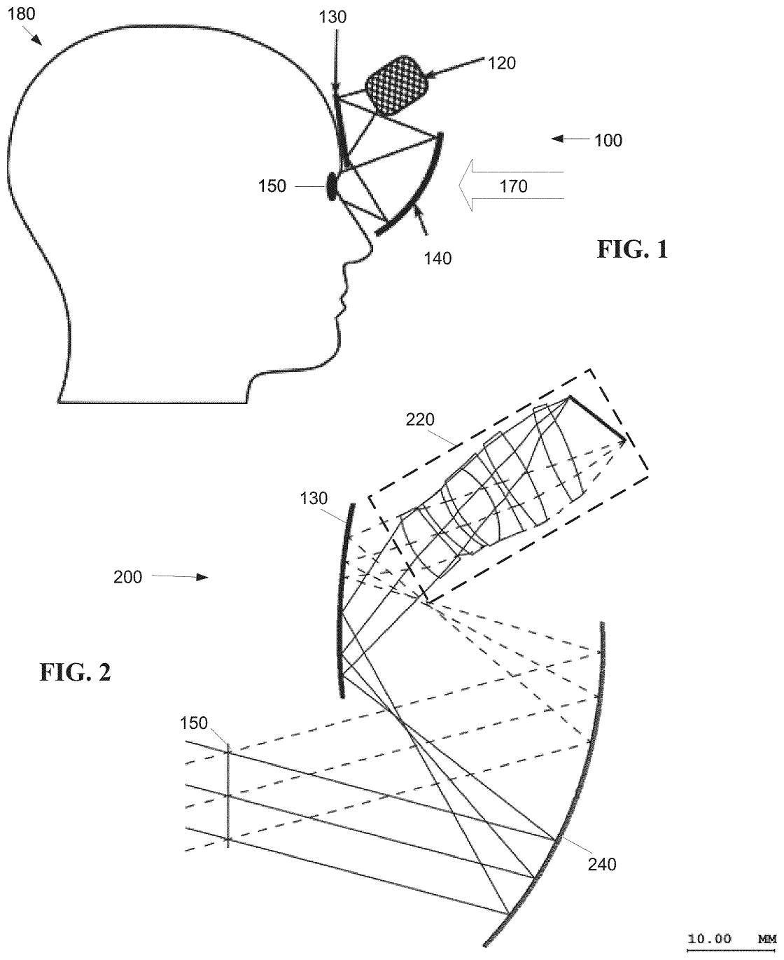

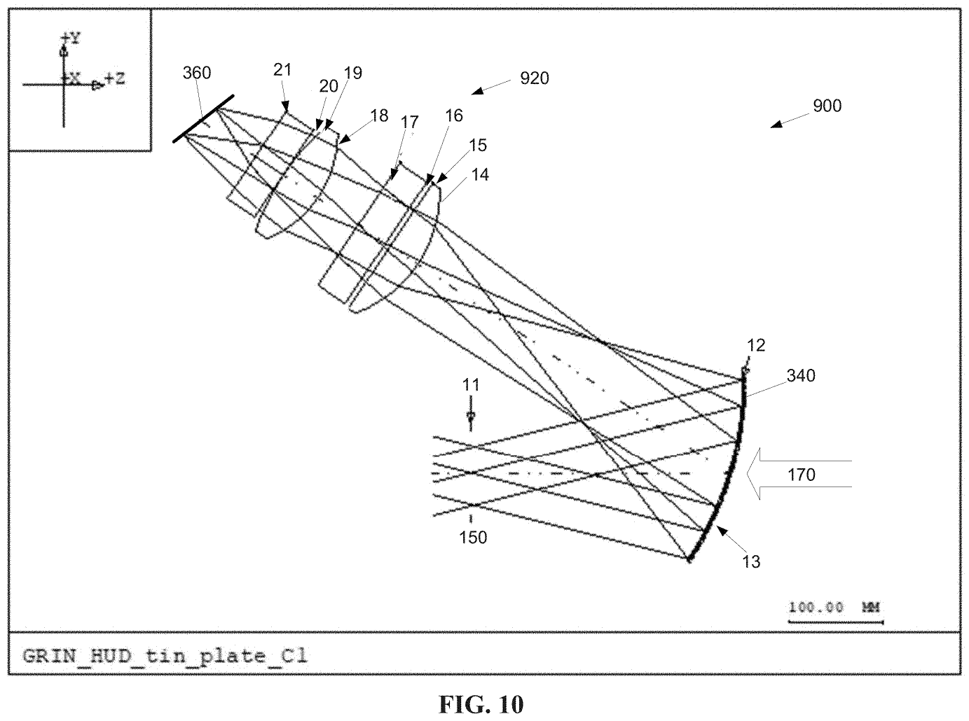

FIGS. 9 and 10 show an exemplary fourth embodiment of a GRIN head-up display (HUD) 900. The HUD 900 is related to the HMD 100 embodiment shown in FIG. 1, but with a different size and space envelope. The HUD embodiment 900 omits the brow mirror of the HMD embodiment 100 (FIG. 1), instead only having a combiner 340. The combiner 340 is spherical in this embodiment, however alternative embodiments may potentially improve performance (whilst adding cost) by introducing a freeform combiner.

The HUD relay optics 920 typically sit above the head of the user and project an image to the eyebox 150 via the combiner. 950 An intermediate image sits between the combiner 340 and the relay optics 920. As in the previous case of the HMD 100 (FIG. 1), this intermediate image is typically highly aberrated due to a tilt angle of the combiner 920. A range of options are possible for a display (not shown) for the relay optics 920, including a CRT screen LED display, and potentially the use of an illumination system projecting onto a diffuser that sits at the image plane of this HUD relay optics 920. It should be noted that, in general, the choice of illumination system does not matter provided that light is provided to the image plane of the HUD projection optics with sufficient luminance and numerical aperture.

The specification for the design of the HUD embodiment 900 was configured to be similar to (but not a direct derivation of) an existing QUK HUD. Under this exemplary embodiment the HUD is modelled as a combination of three optical materials. In particular, the materials of this embodiment are modelled as combinations of printable polymers doped with known nanoparticle data. The base resin is modelled as an optical grade polyester, OKP4HT (which can be printed as a monomer and cured). Nanoparticles of titanium oxide, zirconium oxide, and hollow silica nanospheres are used as index modifiers. All are commercially available nanoparticle materials. While this exemplary set of base materials may be optimized for specific applications, the configuration here demonstrates the core functionality of the invention. Refractive index data of the base inks are listed in Table 11.

TABLE 11
Base material refractive index data for GRIN HUD design

| | N(λ = | N(λ = | N(λ = |
|---|---|---|---|
| Composition | 656.3 nm) | 589.3 nm) | 486.1 nm) |
| OKP4HT + 15% vol ZrO₂ | 1.714867 | 1.719158 | 1.734314 |
| OKP4HT + 10% vol silica | 1.57722 | 1.583813 | 1.601821 |
| nanospheres | | | |
| OKP4HT + 10% vol TiO₂ | 1.733324 | 1.744537 | 1.776138 |

The aperture of the HUD system 900 under the fourth embodiment is defined by a 90 mm diameter entrance pupil at the “eyebox” plane. This aperture is vignetted by apertures defined on the lens elements.

The GRIN lens is described via a model of relative composition (see Boyd [Proc SPIE Vol 10998, 2019]). The refractive index of each GRIN lens is determined by the relative amounts of three base materials, A, B and C as described by Eq. 5 (above).

The system field of view in the entrance pupil is defined by a circular field of semi angle 18°, truncated by a y-plane absolute field of view of 14°. Tables 12-19 prescribe parameters for the HUD system under the fourth embodiment, with reference to the surfaces 11-21 shown in FIG. 10. The system waveband covers the visible spectrum. In this embodiment, the system is defined for three wavelengths in the red, yellow, and blue regions of the spectrum as defined by the Fraunhofer C, D3 and F lines.

The system 900 is illuminated by a display (not shown) placed at the focal plane of the system, emitting light that may sit within the aforementioned spectral waveband. The display may be an emissive micro display based on OLED (organic light emitting diode) or similar technologies.

TABLE 12
GRIN HMD/HUD spectral waveband

| | | | |
|---|---|---|---|
| Wavelengths: | 0.4861 | 0.4861 | 0.6563 |
| Weights: | 1.0000 | 1.0000 | 1.0000 |

TABLE 13
Surface Descriptions

| LABEL | SURFACE | RADIUS | THICKNESS | DIAMETER | MATERIAL |
|---|---|---|---|---|---|
| EYEBOX | 11 | INFINITY | 275.000000 | 90.0000 | — |
| (150) | | | | | |
| COMBINER | 12 | −355.000000 | −400.000000 | 328.0244 | REFLECT |
| (340) | | | | | |
| L1 | 14 | −137.542000 | −35.000000 | 188.6796 | NLAK9 |
| — | 15 | INFINITY | −5.882000 | 155.3497 | — |
| GRIN1 | 16 | INFINITY | −35.000000 | 151.1215 | OKP_GRIN1 |
| — | 17 | INFINITY | −52.107600 | 141.5341 | — |
| L2 | 18 | −121.600000 | −44.000000 | 130.0000 | NPSK53A |
| — | 19 | 267.372000 | −0.557564 | 112.3806 | — |
| GRIN2 | 20 | INFINITY | −35.000000 | 107.1082 | OKP_GRIN2 |
| — | 21 | INFINITY | −72.109638 | 93.1866 | — |
| DISPLAY | 360 | INFINITY | 0.000000 | 65.7888 | — |

TABLE 14
DECENTRES AND TILTS

| Surface | Type | Y Decentre | X Decentre | Y Tilt | X Tilt |
|---|---|---|---|---|---|
| 12 | Tilt/Decentre&Bend | 0.000000 | 0.000000 | −17.000000 | 0.000000 |
| 21 | Tilt/Decentre&Return | −2.373562 | 0.000000 | −18.691038 | 0.000000 |

TABLE 15
VIGNETTING APERTURES

| Surface | Type | X semi-Aperture | Y semi-Aperture |
|---|---|---|---|
| 12 | Square | 130.0 | 100.0 |
| 14 | Square | 80.0 | 50.0 |
| 18 | Circular | 65.0 | — |

TABLE 16
SURFACE 15 ‘OKP_GRIN1’

| | | | |
|---|---|---|---|
| WVL | 656.3 | 587.6 | 486.1 |
| NA | 1.714867 | 1.719158 | 1.734314 |
| NB | 1.577220 | 1.583813 | 1.601821 |
| NC | 1.733324 | 1.744537 | 1.776138 |

TABLE 17
SURFACE 19 ‘OKP_GRIN2’

| | | | |
|---|---|---|---|
| WVL | 656.3 | 587.6 | 486.1 |
| NA | 1.714867 | 1.719158 | 1.734314 |
| NB | 1.577220 | 1.583813 | 1.601821 |
| NC | 1.733324 | 1.744537 | 1.776138 |

TABLE 18
listing of surface 15 inks

| | |
|---|---|
| MA0 | 2.3705E−01 |
| MA2 | −6.8537E−05 |
| MA4 | 2.0206E−08 |
| MA6 | 7.5232E−13 |
| MAX | 0.0000E+00 |
| MAY | −3.4585E−03 |
| MAX2 | −6.6931E−05 |
| MAY2 | −3.1087E−05 |
| MAXY | 0.0000E+00 |
| MAX3 | 0.0000E+00 |
| MAY3 | 5.3956E−07 |
| MAX2Y | 5.0669E−07 |
| MAXY2 | 0.0000E+00 |
| MB0 | 9.1989E−01 |
| MB2 | 3.8348E−05 |
| MB4 | −2.6520E−08 |
| MB6 | −1.6806E−12 |
| MBX | 0.0000E+00 |
| MBY | 3.6989E−03 |
| MBX2 | 6.6513E−05 |
| MBY2 | 7.5155E−06 |
| MBXY | 0.0000E+00 |
| MBX3 | 0.0000E+00 |
| MBY3 | −6.4778E−07 |
| MBX2Y | −5.6383E−07 |
| MBXY2 | 0.0000E+00 |
| MC0 | 9.5854E−03 |
| MC2 | 2.8167E−05 |
| MC4 | 8.9332E−09 |
| MC6 | 6.5466E−13 |
| MCX | 0.0000E+00 |
| MCY | −1.2773E−03 |
| MCX2 | 4.4333E−05 |
| MCY2 | 4.9706E−05 |
| MCXY | 0.0000E+00 |
| MCX3 | 0.0000E+00 |
| MCY3 | 6.4378E−08 |
| MCX2Y | −1.4152E−08 |

TABLE 19
listing of surface 19 inks

| | |
|---|---|
| MA0 | 1.6266E+00 |
| MA2 | −1.8709E−04 |
| MA4 | 4.2289E−08 |
| MA6 | 1.9120E−12 |
| MAX | 0.0000E+00 |
| MAY | −4.2037E−03 |
| MAX2 | −3.1225E−04 |
| MAY2 | −3.5088E−04 |
| MAXY | 0.0000E+00 |
| MAX3 | 0.0000E+00 |
| MAY3 | −1.3735E−06 |
| MAX2Y | −1.2700E−06 |
| MAXY2 | 0.0000E+00 |
| MB0 | 1.3352E−02 |
| MB2 | 1.7040E−04 |
| MB4 | −6.5852E−08 |
| MB6 | −1.4594E−11 |
| MBX | 0.0000E+00 |
| MBY | 1.0597E−03 |
| MBX2 | 3.5823E−04 |
| MBY2 | 3.4371E−04 |
| MBXY | 0.0000E+00 |
| MBX3 | 0.0000E+00 |
| MBY3 | 1.5614E−06 |
| MBX2Y | 8.6895E−07 |
| MBXY2 | 0.0000E+00 |
| MC0 | 1.2628E+00 |
| MC2 | −1.5582E−05 |
| MC4 | 2.4068E−08 |
| MC6 | −5.0957E−12 |
| MCX | 0.0000E+00 |
| MCY | −6.5816E−04 |
| MCX2 | 1.6248E−04 |
| MCY2 | 1.1601E−04 |
| MCXY | 0.0000E+00 |
| MCX3 | 0.0000E+00 |
| MCY3 | −1.5740E−06 |
| MCX2Y | −2.0385E−06 |

It will be apparent to those skilled in the art that various modifications and variations can be made to the structure of the present invention without departing from the scope or spirit of the invention. The description above presents a number of embodiments with varying numbers of GRIN elements. GRIN lenses of general rotationally symmetric form may perform the role of several conventional lens elements. For example, the single GRIN lens embodiment represents such a system, having of an asymmetric freeform GRIN distribution within the lens bulk to compensate the aberrations introduced by a tilted, optically powered, semi-transparent combiner component.

It is an accepted principle in optical design that lens elements may be “split” into additional components. This may often have the effect of increasing performance due to the additional design degrees of freedom offered by extra surfaces, with the associated trade-off that manufacturing complexity increases due to the additional lens count. To this effect, the embodiment shown in FIG. 3A features two GRIN lenses instead of one. Here the optical correction is distributed between the optical surfaces of each lens as well as the GRIN media of each lens, with the optical surfaces primarily correcting the rotationally symmetric aberrations of the system and the asymmetric GRIN correcting the asymmetric aberrations induced by the combiner. It follows that alternative embodiments that incorporate three or more GRIN lenses represent a derivative form of the above described embodiments.

It also follows that the GRIN relay lens may consist of one or more GRIN lenses in combination with conventional homogeneous lenses, as presented by embodiment shown in FIG. 4, where freeform GRIN lenses operate in conjunction with conventional homogeneous lenses. Similarly, further derivative forms (not shown) may also be prepared whereby tilted and decentred lenses (being the state of the art) may be combined with one or more GRIN lenses.

The embodiments described in this application may have utility in a number of information display applications where a tilted semi-transparent combiner is necessary to allow light to clear a space envelope occupied by the user. This will typically be the head of a user but could also represent a broader space envelope such as a vehicle or aircraft cockpit.

The embodiments may be applied at different scales, both larger and smaller depending on the user and application. Most commonly, system size varies between applications that project information into a single eye, or both eyes of a user. To this effect several embodiments have been included that image to a single eye of a human user, with one example embodiment featuring a larger, flatter eyebox that images to both eyes. It follows logically that embodiments may include even larger scales for systems featuring multiple users, or smaller scales where applicable.

In view of the foregoing, it is intended that the present invention cover modifications and variations of this invention provided they fall within the scope of the following claims and their equivalents.

1. An optical projection assembly for directing a first image from a first source to an eyebox of a user and combined with light from a second source comprising:
a relay optic comprising a plurality of refractive gradient-index (GRIN) components arranged to receive the first image; and
a tilted, partially reflective combiner with positive optical power comprising a first surface arranged in a tilted or decentred fashion with respect to a received light from the second source for transmitting the light received from the second source to the eyebox, and a second surface opposite the first surface arranged to receive and project the first image from the relay optic and transmit the light received from the second source; and
wherein the plurality of refractive GRIN components are configured to reduce a perceivable aberration of the first image introduced by the combiner.

2. The optical projection assembly of claim 1, wherein the plurality of refractive GRIN components consists of two gradient-index components.

3. The optical projection assembly of claim 1, wherein at least one of the plurality of refractive GRIN components comprises a doublet further comprising a glass lens backed by a GRIN plate.

4. The optical projection assembly of claim 1, wherein:
each of the plurality of refractive GRIN components has a non-rotationally symmetric distribution of refractive index; or
each of the plurality of refractive GRIN components has a rotationally symmetric refractive index distribution that is:
tilted with respect to an optical axis of the relay optic; and/or
decentred with respect to an optical axis of the relay optic.

5. The optical projection assembly of claim 1, further comprising a mirror configured to reflect the first image from the relay optic to the combiner,
wherein the optical projection assembly is arranged for housing in a head mounted display, HMD.

6. The optical projection assembly of claim 1, wherein the optical projection assembly is arranged for housing in a head-up display, HUD.

7. The optical projection assembly of claim 1, wherein each of the plurality of refractive GRIN components has a value compensating out one or more chromatic aberrations introduced by the combiner.

8. The optical projection assembly of claim 1, wherein the plurality of refractive GRIN components provide colour-corrected imagery.

9. The optical projection assembly of claim 1, wherein outer surfaces of each of the plurality of refractive GRIN components share a common optical axis of symmetry.

10. The optical projection assembly of claim 1, wherein the first source comprises an electronic display disposed at a focal plane of the relay optic.

11. The optical projection assembly of claim 1, wherein the light received from the second source comprises light from the outside world.

12. A method for manufacturing an optical projection assembly configured to combine received external light with a projected image from an electronic display at an eyebox of a user, comprising steps of:
providing a relay optic comprising a plurality of gradient-index (GRIN) components;
arranging the electronic display at a focal plane of the relay optic;
arranging a mirror to receive and reflect an image from the relay optic;
arranging a partially reflective combiner with positive optical power comprising a first surface in a tilted or decentered fashion with respect to an external light to transmit the external light to the eyebox, and a second surface opposite the first surface arranged to receive and project the image received from the relay optic via the mirror.

13. The method of claim 12, further comprising a step of configuring the plurality of GRIN components to reduce a perceivable aberration of the image introduced by the partially reflective combiner according to an arrangement of the partially reflective combiner.

14. The method of claim 12, wherein the plurality of GRIN components consists of two refractive gradient-index components.

15. The method of claim 12, wherein at least one of the plurality of GRIN components comprises a doublet further comprising a glass lens backed by a GRIN plate.

16. An optical projection assembly for directing a first image from a first source to an eyebox of a user and combined with light from a second source comprising:
a relay optic comprising a refractive gradient-index (GRIN) component arranged to receive the first image; and
a tilted, partially reflective combiner with positive optical power comprising a first surface arranged in a tilted fashion with respect to a received light from the second source for transmitting the light received from the second source to the eyebox, and a second surface opposite the first surface arranged to receive and project the first image from the relay optic and transmit the light received from the second source; and
wherein the refractive GRIN component is configured to reduce a perceivable aberration of the first image introduced by the combiner.

17. The optical projection assembly of claim 16, wherein the refractive GRIN component comprises a doublet further comprising a glass lens backed by a GRIN plate.

18. The optical projection assembly of claim 16, wherein:
The refractive GRIN component has a non-rotationally symmetric distributions of refractive index; or
the refractive GRIN component has a rotationally symmetric refractive index distribution that is:
tilted with respect to an optical axis of the relay optic; and/or
decentred with respect to an optical axis of the relay optic.

19. The optical projection assembly of claim 16, further comprising a mirror configured to reflect the first image from the relay optic to the combiner,
wherein the optical projection assembly is arranged for housing in a head mounted display, HMD.

20. The optical projection assembly of claim 16, wherein the optical projection assembly is arranged for housing in a head-up display, HUD.

21. The optical projection assembly of claim 19, wherein the GRIN component has a value compensating out one or more chromatic aberrations introduced by the mirror and/or the combiner.

22. The optical projection assembly of claim 21, wherein the GRIN component is configured to provide colour-corrected imagery.

23. The optical projection assembly of claim 16, wherein the first source comprises an electronic display disposed at a focal plane of the relay optic.

24. The optical projection assembly of claim 16, wherein the light received from the second source comprises light from the outside world.

25. A method for manufacturing an optical projection assembly configured to combine received external light with a projected image from an electronic display at an eyebox of a user, comprising steps of:
providing a relay optic comprising a gradient-index (GRIN) component;
arranging the electronic display at a focal plane of the relay optic;
arranging a mirror to receive and reflect an image from the relay optic;
arranging a partially reflective combiner with positive optical power comprising a first surface in a tilted fashion with respect to an external light to transmit the external light to the eyebox, and a second surface opposite the first surface arranged to receive and project the image received from the relay optic via the mirror.

26. The method of claim 25, further comprising step of configuring the GRIN component to reduce a perceivable aberration of the image introduced by the combiner according to an arrangement of the combiner.

27. The method of claim 25, wherein the GRIN component comprises a doublet further comprising a glass lens backed by a GRIN plate.
